(19) United States
(12) Patent Application Publication
(10) Pub. No.: US 2008/0242822 A1
(43) Pub. Date: Oct. 2, 2008

(54) POLYURETHANE FORMULATION USING PROTEIN-BASED MATERIAL

(76) Inventor: RICHARD A. WEST, Lakewood, OH (US)

Correspondence Address: FAY SHARPE LLP, 1100 SUPERIOR AVENUE, SEVENTH FLOOR, CLEVELAND, OH, 44114, US

(21) Appl. No.: 12/061,114

(22) Filed: Apr. 2, 2008

Related U.S. Application Data
(60) Provisional application No. 60/921,410, filed on Apr. 2, 2007.

(51) Int. Cl. C08L 89/00

(52) U.S. Cl. 527/204

(57) ABSTRACT

A method is provided for preparing a polyol from a protein-based precursor material, the polyol substitute thus produced, and a process for the use of the protein-based polyol substitute thus prepared for the further preparation of polyurethane.

This application claims the priority benefit of, and expressly incorporates herein by reference, U.S. provisional application Ser. No. 60/921,410, filed Apr. 2, 2007.

### BACKGROUND OF THE INVENTION

The present invention relates generally to the use of a protein-based material to generate a conventional polyol-substitute. Specifically, the invention relates to the use of a protein suitable for mixing with an aqueous or other solvent to generate a material for use in place of conventional polyols, or in combination therewith.

By general definition, a polyol is a polyhydric alcohol including three or more hydroxyl groups. Those with three hydroxyl groups are glycerols and those with more than three are commonly called sugar alcohols and have the general formula CH₂OH(CHOH)ₙCH₂OH, where n may be from 2 to 5. Polyols find particular relevance with regard to the preparation and production of polyurethane products.

A polyurethane is made by mixing together an isocyanate and a polyol in a predetermined proportion. This generates a thermoplastic polymer, which can then be made into a thermosetting polymer, produced by the condensation reaction of the polyisocyanate and the polyol or the hydroxyl-containing material. Given the basic building blocks of the polyurethane, they can be tailored to generate materials which vary in properties including, among others, high elastic modulus, good electrical resistance, moisture resistance, excellent hardness, gloss, flexibility, abrasion resistance, adhesion, weather resistance, chemical resistance, and thermal conductivity.

Polyurethanes may be supplied in the form of fiber, coatings, elastomers, and foams. Of particular interest herein are polyurethanes in the form of sprayed foams. It will be apparent to the skilled artisan, however, that the attributes that make the subject inventive disclosure applicable to sprayed foams applies equally to all classes of polyurethanes. Fiber polyurethanes are used in textile products requiring exceptional elasticity and, for example, in bristles for brushes. Polyurethanes for coatings find applications in baked coatings, wire coatings, painted linings, maintenance paints, and masonry coatings. Those polyurethanes in the form of elastomers may find particular use as sealants and caulking agents, adhesives, films and linings, encapsulation for electronic parts, binders for rocket propellants, abrasive wheels and other mechanical items, auto bumpers, fenders and other components. Finally, polyurethanes suitable for use as foams may be flexible, such as those based on polyoxypropylene-diols, having a molecular weight of 2,000 and triols having a molecular weight of 4,000, or they may be rigid foams based on polyethers made from sorbitol, methylglucacide, or sucrose. Uses for foam-type polyurethanes include furniture, mattresses, laminates and linings, floor leveling, seat cushions and other automotive accessories, carpet underlay, upholstery, absorbants for crude oil spills on sea water, packaging and packing materials, building insulation, marine flotation, sound proofing, ship building, transportation insulations for box cars, refrigerated cars, hopper cars, trucks and trailers, insulation for storage tanks, ships hulls and pipelines, and auto bumpers. The foregoing is merely exemplary and by no means intended to be an exclusive list of potential applications for these materials.

The form of the polyurethane and the specific use therefore depends greatly on the polyisocyanate and polyol used, the precise ratio of these components to one another, other ingredients or components that may be added, and the processing parameters employed. Generally, the components are combined in liquid form and as the liquid is mixed, initiating an exothermic reaction, the mixture becomes increasingly viscous and eventually forms a solid mass.

There are many commercial grades of isocyanates that may be used for making polyurethane. Each grade gives different properties to the end product, requires different curing systems, and in most cases requires different processing parameters. An important property to be considered in choosing an isocyanate is the functionality, or the number of isocyanate groups (—NCO) per isocyanate molecule. Some of the more common isocyanates used in making polyurethanes include MD (diphenolmethane 4,4-diisocyanate), NDI (naphthalene 1,5-diisocyanate), TDI (toluene diisocyanate), and HDI (hexamethylene diisocyanate). For example, flexible foam is generally made with TDI. The most widely used isocyanate for producing polyurethanes is MDI, which exhibits a functionality of about 2.8.

There are two main types of polyols used in the production of polyurethanes. These are polyethers and polyesters. For example, polyethylene adipate is a commonly used polyester, and poly(tetramethylene ether)glycol is a commonly used polyether. Of the polyethers that can be used, those most commonly used are polyethers having a relatively low molecular weight, ranging from 500 to 3,000, and that are manufactured from propylene oxide and ethylene oxide units. The functionality of a polyether polyol can be varied and is normally 2 for elastomer polyurethanes, approximately 3 for flexible foam polyurethanes, and up to 6 or more for rigid foam polyurethanes. Polyester polyols are typically produced by the condensation reaction of a diol, such as ethylene glycol, with a dicarboxylic acid. Polyester polyols tend to be more expensive and usually viscous and difficult to handle, however, they develop polyurethanes with superior tensile, abrasion, flex and oil resistant properties. Polyester polyurethanes, however, suffer from low hydrolysis resistance. Given that the polyesters tend to be more expensive, but also to have better properties, it is common to use a combination of polyols to achieve a desired outcome. In addition to the polyol and isocyanate, the polyurethane may further contain additives, such as catalysts, chain extenders, flow agents, flame retardants, pigments, surfactants, fillers, and other such additives.

Historically, the polyol components of a polyurethane have been at least partial petroleum-based polyols. However, those industries employing polyurethanes, like many other industries, are facing serious environmental concerns. In an effort to respond to these concerns, polyols that have previously been petroleum-based have been replaced by what are commonly called “green” components. The term “green” as used herein refers to components which are environmentally friendly. In the context of polyols, such components might include castor oil and soy oil. However, even though this type of component is responsive to the environmental concerns posed by some polyols, it nonetheless has drawbacks of its own. One of the most pronounced drawbacks to the use of, for example, soy oil instead of more conventional polyols is the difficulty of keeping the soy polyol in suspension before and during processing. Therefore, it is desirable to provide a polyol source or a substitute therefore which is green and overcomes the foregoing difficulties.

### SUMMARY OF THE INVENTION

In general, the present invention provides a method for preparing a protein-based material that can be used in place of or in combination with more conventional polyols.

In one aspect of the invention, therefore, there is provided a method for preparing a polyol-like material from a protein-based precursor.

In another aspect of the present invention, there is provided a method for the preparation of polyurethane from a combination of an isocyanate and a protein-based polyol-like material used as the B-side component of the polyurethane formulation.

In yet another aspect of the present invention, there is provided a method for the preparation of polyurethane from an isocyanate and a combination of a protein-based polyol-like material and a conventional polyol, the combination being used as the B-side component of the polyurethane formulation.

In still another aspect of the present invention, there is provided a method for the preparation of polyurethane foam from an isocyanate and a protein-based polyol-like material, a combination of protein-based polyol-like materials, or a combination of one or more protein-based polyol-like materials and one or more conventional polyols, the combination being used as the B-side component of the polyurethane formulation.

Still other features and benefits of the invention will become apparent to those skilled in the art upon reading and understanding the following detailed description.

### DETAILED DESCRIPTION OF THE INVENTION

In an embodiment of the present invention, there is provided a method for the preparation of a liquid or aqueous-based polyol-substitute from a protein precursor material. As is set forth above, certain polyols have fallen out of favor for use in industries where environmental concerns require the use of green components to produce green products. One specific example of this situation is the preparation of polyurethane products and materials, more specifically polyurethane foam products and materials. In preparing such materials, a chosen polyisocyanate-polyol system is combined in a liquid form. These components, optionally along with other additives, undergo an exothermic reaction to produce a polyurethane. During this reaction the liquid mixture become increasingly viscous and eventually forms a solid mass. Depending on the particular isocyanate-polyol system, and the ratio of the base components of the system, the resulting product may be produced in the form of a fiber, a coating, an elastomer, or a flexible or rigid foam.

Of particular interest herein is the production of sprayable, rigid polyurethane foam, though other forms of polyurethanes will find equal advantage employing the present invention. Foams find application in the building industry as roofing material and as sprayed-in insulation, as well as in many other industrial applications.

In one embodiment of the invention, the polyurethane is comprised of about a 1 to 1 ratio mix of polyisocyanate to the conventional polyol substitute provided herein. The system is generally referred to as having an A side (isocyanate) and a B side (polyol). The polyisocyanate, or A side, of choice for this particular application is diphenylmethane 4,4-diisocyanate or MDI, though other isocyanates may be used. The B side for use in this application is a protein-based polyol substitute prepared from a protein precursor material and an aqueous solvent. As used herein, the term “protein-based polyol substitute” and versions thereof are intended to include combinations of one or more such protein-based polyol substitutes and combinations of these materials with one or more conventional petroleum-based polyols.

The protein-based precursor material may be derived from any suitable animal or vegetable protein. A protein is a biological macromolecule made up of various a-amino acids that are joined by peptide bonds. A peptide bond is an amide bond formed by the reaction of an α-amino group (NH₂) of one amino acid with the carboxyl group (COOH) of another, as shown below. Proteins generally contain from 50 to 1000 amino acid residues per polypeptide chain.

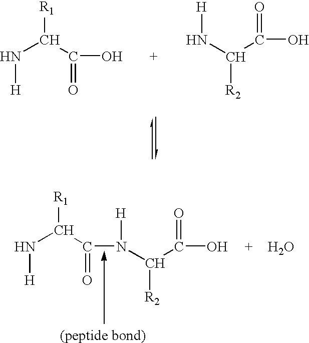

Most proteins are structurally altered after synthesis through chemical modification or processing. These alterations help the cell determine a protein's fate, such as whether that protein is active or inactive, how long the protein will function, and to some degree the location where that protein will function. Chemical modifications, which are additions of chemical groups to the R groups in the amino acids, are made after translation. Such modifications may include the attachment of a phosphate group, by a process known as phosphorylation, to the alcohol group on the amino acid. Other alterations include those such as alteration of the amino acid proline in proteins such as collagen by being hydroxylated, which means that an alcohol group is attached, or the alteration of other amino acids with amino groups in their R region, such as lysine or arginine, which may be chemically modified through methylation, which is the addition of a methyl group (—CH₃), or through acetylation, in which an acetyl group (—CH₃CO) is added. Larger modifications, such as the addition of a carbohydrate group, occur to create glycoproteins in specialized organelles termed Golgi apparati. Each alteration allows the protein to serve more specific functions.

Polyurethanes, as is set forth above, are formulated from an A-side isocyanate and a B-side, in this case, protein-based polyol substitute. In addition to the protein-based polyol substitute, the B-side components may further include a fire retardant, a blowing agent, a surfactant, a smoke retardant, a flame retardant, a cell opener, and one or more catalysts. For example, Table I sets forth the A- and B-side components for a specific polyurethane system including a protein-based polyol substitute, intended for use as a low density insulation material

TABLE I

| Polyurethane | | Fraction % | Parts/wt % |
|---|---|---|---|
| A-side | Isocyanate: MDI¹ | | 102.39 |
| B-side | | | 100/ |
| | Polyol: | | |
| | Aluminum trihydrate⁴ | 9.46 | |
| | PCF Phosphate⁵ | 28.51 | |
| | Water⁶ | 16.69 | |
| | Siltick 2740⁷ | 1.67 | |
| | BZ 54⁸ | 31.99 | |
| | Ortegal 500⁹ | 1.25 | |
| | Soy-based aqueous polyol² | 3.06 | |
| | DMEA³ | 2.36 | |
| | ADD. 108³ | 4.17 | |
| | CAT-41³ | 0.83 | |
| Total wt % | | | 100% |

¹MDI = diphenylmethane 4,4-diisocyanate
²Soy-based aqueous polyol prepared from soy powder and H₂O
³Catalyst = may be one or a combination of catalysts.
⁴powder fire retardant
⁵liquid fire retardant
⁶blowing agent
⁷Silicone surfactant
⁸Non-reactive bromine flame/smoke retardant
⁹Cell opener

In the foregoing formulation, the A-side contains 31.50% available NCO functionality. On the B-side, the water provides 6300 OH value, the BZ-54 provides 180 OH value, the soy, protein-based polyol provides 28 OH value, and the CAT-41 provides 120 OH value. The A:B ratio for this mixture is 102.39 parts:100 parts. The ratio of water to soy in the B-side mixture is about 6 parts to 1 part.

With regard to the B-Side components, fire retardants may optionally be used and take the form of powder or fluid. For example, aluminum trihydrate is a powder flame retardant, and the phosphate fire retardant is added in the liquid form. In the above formulation, the powder fire retardant may be added as up to about 50% of the B-side formulation, while the phosphate may be used as between about 5% and 20% of the B-side formulation. Additionally, a flame and/or smoke retardant may be included as up to 40% of the mixture. An example of this material is a non-reactive bromine compound. However, and notwithstanding the foregoing, it is possible with the subject protein-based polyols substitute to eliminate or greatly reduce the need for phosphate fire retardants given that the phosphate may be added to the protein, as set forth hereinabove. This is a strong advantage to use of the subject material, especially when producing polyurethanes for use in the building industry where fire resistance is of great benefit to the end user.

The blowing agent, which in the above instance is nothing more than water, converts the carbon in the isocyanate component to carbon dioxide which creates bubbles and helps to form the structure of the foam. In addition to water, other suitable blowing agents include pentane and 245 FA. This component may be added as up to 60% of the B-side mixture. In conjunction with the blowing agent, a cell opener, which functions to open the cells of the bubbles, allowing air to enter the interior voids before the carbon dioxide escapes, may be added as from about 0.0% to about 2% of the mixture. The cell opener prevents the polyurethane from shrinking down and helps it maintain its form.

Another component that may be included is a surfactant, such as a silicone compound. This component may be added as from about 0.5% to about 3% of the mixture, depending on the system. However, in that instance where certain protein-based polyols substitutes are employed the protein itself acts as a surfactant for the system, providing the necessary support for the system during the foaming reaction. An example of such a protein includes egg white protein. Conventional petroleum-based polyols do not demonstrate this same self-surfacting property. One practical advantage to not having to add surfactant to the system is the reduction in cost of formulating the polyurethane.

Catalysts may be added at levels needed for various environmental conditions in amounts from about 5% of the B-side formulation. There may be one catalyst used, or a combination of catalysts may be used.

In addition to the foregoing, pigments and other fillers may be added. Each additive, the type used and the amount employed is determined on a system-by-system basis, depending on the isocyanate and protein-based polyols substitute chosen, the required properties for the end product, and the processing parameters employed.

As is stated hereinabove, while this particular polyurethane mixture finds application in sprayed-in-place roofing and insulation, the same type of polyurethane system, using a protein-based precursor material as a polyols substitute, will find equal application in cushion material, in construction applications of various sorts, in insulation and flotation for spas and boats, and in many other applications.

In practice, the A- and B-sides are mixed in a conventional polymer reactor. The B-side, or protein-based polyols substitute, may include any of the additives mentioned in Table 1, or any others known to the skilled artisan. It may also be useful to blend the B-side components and then contact the mixture with the A-side isocyanate component. Depending on the type of polyurethane being prepared, the mix, once reacted, may be blown/sprayed, molded, or otherwise worked for a specific purpose.

The protein-based polyols substitute, prepared from the protein precursor material, imparts many advantages to the preparation of a polyurethane. As has been mentioned above, the processing and product are green, as compared to products prepared using less environmentally friendly petroleum-based polyols. In addition, the chemistry of the protein allows for the addition of certain groups at open sites on the molecules to enhance specific performance characteristics. For example, phosphorus molecules added to open cites on the protein render the protein-based polyols substitute fire resistant. In like manor, other molecules may be grafted or bonded on to the protein to achieve certain attributes in the finished product or to enhance processing. In this manner, the strength, flexibility, abrasion resistance, thermal properties, and others may be specifically tailored to achieve certain results. In addition to advantages of this type, there is also a considerable cost advantage to use of the protein-based precursor to generate the polyols substitute. Using conventional polyols, the foam polyurethane prepared herein may cost anywhere from $0.70 to $0.90/pound. Using the protein-based precursor to prepare the polyol, the cost is considerably reduced. Further, it is seen in the Table 1 above that very little of the actual polyols substitute need be included, only 3.06% of the mixture.

The invention has been described with reference to the preferred embodiment. Clearly the advantages and benefits range from environmental, to chemical processing and product parameters, to cost efficiency. Modifications and alterations will occur to others upon reading and understanding this specification. It is intended to include all such modifications and alterations in so far as they come within the scope of the appended claims or the equivalents thereof.

Having thus described the invention, it is now claimed:

1. A method for preparing a polyol useful in preparing a polyurethane comprising:
mixing a protein-based precursor material with a solvent to form the polyurethane.

2. The method of claim 1 wherein the solvent is water.

3. The method of claim 1 wherein the protein-based precursor material is an animal protein or vegetable protein.

4. The method of claim 3 wherein the protein-based precursor material is egg white.

5. A process for the preparation of polyurethane comprising the steps of:
providing an A-side component comprising an isocyanate;
providing a protein-based precursor material;
mixing the protein-based precursor material with a solvent to produce a protein-based polyol substitute as a B-side component; and
reacting the A-side component and the B-side component to form a polyurethane.

6. The process of claim 5 wherein the A-side component is MDI, NDI, TDI or HDI.

7. The process of claim 5 wherein the protein-based precursor material is an animal protein or a vegetable protein.

8. The process of claim 7 wherein the protein-based precursor material is egg white.

9. The process of claim 5 wherein the solvent is water.

10. The process of claim 5 wherein the A-side:B-side ratio is about 102:100.

11. A polyurethane foam comprising an isocyanate in combination with a protein-based polyol substitute.

12. The polyurethane foam of claim 11 wherein the protein-based polyol substitute is prepared by mixing a protein-based precursor material with a solvent.

13. The polyurethane foam of claim 11 wherein the ratio of isocyanate to protein-based polyol substitute is about 1:1.

14. The polyurethane foam of claim 11 wherein the protein-based precursor material is an animal protein or vegetable protein.

15. The polyurethane foam of claim 14 wherein the protein-based precursor material is egg white.
